(19) United States
(12) Patent Application Publication
(10) Pub. No.: US 2025/0328540 A1
(43) Pub. Date: Oct. 23, 2025

(54) METHOD, APPARATUS, ELECTRONIC DEVICE, AND COMPUTER PROGRAM PRODUCT FOR DATA RETRIEVAL

(71) Applicant: Beijing Volcano Engine Technology Co., Ltd., Beijing (CN)

(72) Inventors: Guanxiao He, Beijing (CN); Yingchun Zou, Beijing (CN); Yang Gao, Beijing (CN); Xiaoming Zhao, Beijing (CN)

(21) Appl. No.: 19/060,999

(22) Filed: Feb. 24, 2025

(30) Foreign Application Priority Data
Apr. 19, 2024 (CN) 202410473874.2

(51) Int. Cl. G06F 16/248; G06F 16/215; G06F 16/383

(52) U.S. Cl. CPC G06F 16/248; G06F 16/215; G06F 16/24522; G06F 16/383

(57) ABSTRACT

Embodiments of the present disclosure relate to a method, an apparatus, an electronic device, and a computer program product for table retrieval. The method includes determining a table query similarity between a user query and each data table in a database based on the user query, a data table summary, and a field name. The method further includes retrieving a target data table set based on the table query similarity. The method further includes determining a field query similarity between the user query and each field based on the user query and the field name. The method further includes retrieving a target field set based on the field query similarity. Furthermore, the method further includes determining a retrieval result of data retrieval based on the target data table set and a corresponding target field set.

### CROSS-REFERENCE TO RELATED APPLICATION(S)

This application claims priority to Chinese Application No. 202410473874.2 filed Apr. 19, 2024, the disclosure of which is incorporated herein by reference in its entirety.

### FIELD

The present application relates to the field of computer technologies, and in particular, to a method, an apparatus, an electronic device, and a computer program product for data retrieval.

### BACKGROUND

In today's information age, the value of data is increasingly valued, and the emergence of massive data makes it an important topic of technical research and development to retrieve information required by users therefrom efficiently and accurately. Therefore, a data table retrieval task comes into being, which includes retrieving a data table related to a user query from a database including a large-scale data table set to help the user quickly and accurately obtain information in the database.

Through the data table retrieval technology, information required by a user can be quickly and accurately extracted from massive data, providing important support for decision making, data analysis, scientific research exploration, and the like. The data table retrieval not only improves the efficiency of information retrieval, but also provides users with more accurate and convenient data services, promoting the development of various industries. Therefore, the table retrieval technology is of great significance in the current information age and has a far-reaching impact on promoting data-driven decision making, scientific research, and the like.

### SUMMARY

Embodiments of the present disclosure provide a method, an apparatus, an electronic device, a computer program product, and a medium for data retrieval.

According to a first aspect of the present disclosure, a method for data retrieval is provided. The method includes determining a table query similarity between a user query and each data table in a database based on the user query, a data table summary, and a field name. The method further includes retrieving a target data table set from the database based on the table query similarity, where the target data table set includes data associated with the user query. The method further includes determining a field query similarity between the user query and each field of each data table in the target data table set based on the user query and the field name. The method further includes retrieving a target field set from each data table in the target data table set based on the field query similarity. In addition, the method further includes determining a retrieval result of the data retrieval based on the target data table set and the corresponding target field set.

According to a second aspect of the present disclosure, an apparatus for data retrieval is provided. The apparatus includes a table similarity determination module configured to determine a table query similarity between a user query and each data table in a database based on the user query, a data table summary, and a field name. The apparatus further includes a target data table retrieval module configured to retrieve a target data table set from the database based on the table query similarity, where the target data table set includes data associated with the user query. The apparatus further includes a field similarity determination module configured to determine a field query similarity between the user query and each field of each data table in the target data table set based on the user query and the field name. The apparatus further includes a target field determination module configured to retrieve a target field set from each data table in the target data table set based on the field query similarity. In addition, the apparatus further includes a retrieval result determination module configured to determine a retrieval result of the data retrieval based on the target data table set and the corresponding target field set.

According to a third aspect of the present disclosure, an electronic device is provided. The electronic device includes a processor and a memory coupled to the processor. The memory has instructions stored thereon. The instructions, when executed by the processor, cause the electronic device to perform the method according to the first aspect.

In a fourth aspect of the present disclosure, a computer-readable storage medium is provided. The computer program product is tangibly stored on a non-transitory computer-readable medium and includes computer-executable instructions. The computer-executable instructions, when executed, cause a computer to perform the steps of the method according to the first aspect of the present disclosure.

In a fifth aspect of the present disclosure, a computer-readable storage medium is provided. The computer-readable storage medium has one or more computer instructions stored thereon, where the one or more computer instructions are executed by a processor to implement the method according to the first aspect.

The summary is intended to introduce a selection of concepts in a simplified form, which will be further described in detail in the following description of embodiments. The summary is not intended to identify key or essential features of the claimed subject matter, nor is it intended to limit the scope of the claimed subject matter.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference numbers refer to the same or similar elements, where:

FIG. 1 illustrates a schematic diagram of an example environment in which a device and/or method according to an embodiment of the present disclosure can be implemented;

FIG. 2 illustrates a flowchart of a method for data retrieval according to an embodiment of the present disclosure;

FIG. 3A illustrates a flowchart of a process of data retrieval according to an embodiment of the present disclosure;

FIG. 3B illustrates a schematic diagram of a process of recalling a data table set according to an embodiment of the present disclosure;

FIG. 3C illustrates a schematic diagram of a process of recalling a field set according to an embodiment of the present disclosure;

FIG. 4 illustrates a schematic diagram of a process of field recall using data popularity according to an embodiment of the present disclosure;

FIG. 5 illustrates a flowchart of a process of training a ranking model according to an embodiment of the present disclosure;

FIG. 6A-FIG. 6D jointly illustrate schematic diagrams of processes of data table retrieval and field retrieval according to an embodiment of the present disclosure;

FIG. 7 illustrates a block diagram of an apparatus for data retrieval according to some embodiments of the present disclosure; and

FIG. 8 illustrates a block diagram of an electronic device according to an embodiment of the present disclosure.

The same or similar reference numbers refer to the same or similar elements throughout the drawings.

### DETAILED DESCRIPTION OF EMBODIMENTS

It is understandable that before using the technical solutions disclosed in the embodiments of the present disclosure, the user should be informed of the type, range of use, use scenario, and the like of personal information involved in the present disclosure in an appropriate manner in accordance with relevant laws and regulations, and the user's authorization should be obtained.

The embodiments of the present disclosure will be described in more detail below with reference to the drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and the embodiments of the present disclosure are only for exemplary purposes, and are not intended to limit the protection scope of the present disclosure.

In the description of the embodiments of the present disclosure, the term “include/include” and similar terms should be understood as open inclusion, that is, “include/include but is not limited to”. The term “based on” should be understood as “at least partially based on”. The term “one embodiment” or “this embodiment” should be understood as “at least one embodiment”. The term “first”, “second”, etc. may refer to different or the same objects, unless explicitly stated. Other explicit and implicit definitions may also be included below.

As mentioned above, the data retrieval task involving data table retrieval plays an important role in the current information age. Current data retrieval technologies usually only perform data table retrieval, without performing corresponding field retrieval. However, users cannot complete corresponding data queries when they only obtain data table retrieval results without field retrieval results. To this end, the embodiments of the present disclosure propose a solution for data retrieval. The solution adopts a two-stage query. First, a data table set is retrieved according to a user query, a data table summary, and a field name, and then a field set is retrieved from each data table according to the user query and the field name. Then, the data table set and a corresponding field set are returned to the user as a retrieval result. Therefore, according to the solution of the embodiments of the present disclosure, when a user performs data retrieval, not only a data table retrieval result but also a corresponding field retrieval result can be returned, ensuring that the retrieval result better meets the needs of the user, providing the user with a higher-quality data retrieval experience, and being widely applicable and capable of supporting complex query requirements.

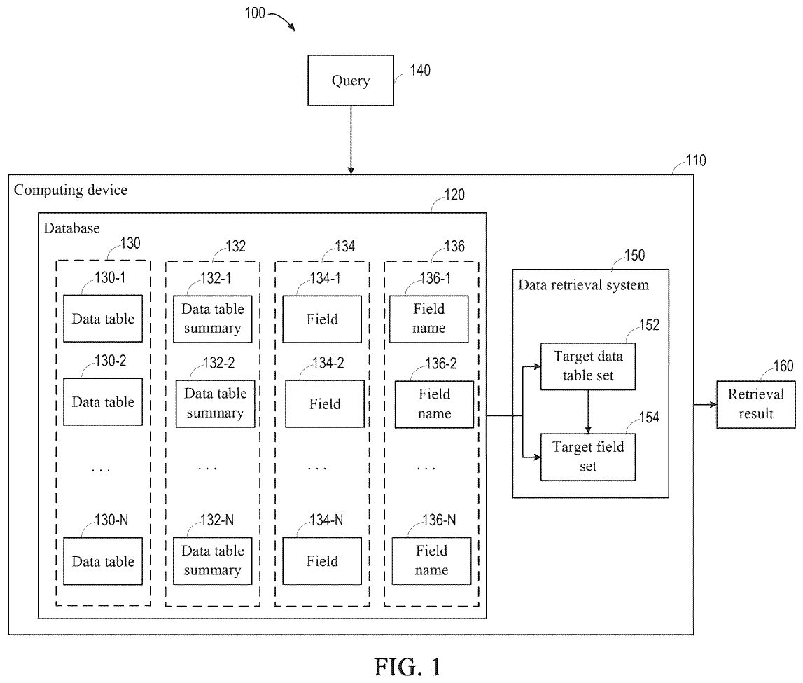

FIG. 1 illustrates a schematic diagram of an example environment in which a device and/or method according to an embodiment of the present disclosure can be implemented. As shown in FIG. 1, the example environment 100 may include a computing device 110, which may be a user terminal, a mobile device, a computer, or the like, and may also be a computing system, a single server, a distributed server, or a cloud-based server. The computing device 110 may include a database 120. The database 120 may include a data table 130-1, a data table 130-2, . . . , and a data table 130-N (which are individually or collectively referred to as data tables 130 hereinafter). It should be understood that the database 120 may include millions or even tens of millions of data tables, and the database 120 may be a set of databases, which is not limited to a single database. In addition, the database 120 may include a data table summary 132-1, fields 134-1, and corresponding field names 136-1 corresponding to the data table 130-1. For example, the data table summary 132-1 may be a description text of the data table 130-1, which records information related to the data table 130, including but not limited to, for example, a table name, a corresponding application, a usage scenario, and the like. In some embodiments, the data table summary may be generated through the data table by using a pre-trained language model. The fields 134-1 are all fields included in the data table 130-1. In addition, the database 120 may further include a data table summary 132-2, fields 134-2, and field names 136-2 corresponding to the data table 130-2, and a data table summary 132-N, fields 134-N, and field names 136-N corresponding to the data table 130-N. The data table summaries 132-1 to 132-N are individually or collectively referred to as data table summaries 132 hereinafter, the fields 134-1 to 134-N are individually or collectively referred to as fields 134 hereinafter, and the field names 136-1 to 136-N are individually or collectively referred to as field names 136 hereinafter.

As shown in FIG. 1, the computing device 110 may receive a query 140 (also referred to as a first query) from a user. For example, the query 140 may be “What are the recent daily active users of various applications”, to retrieve the daily active user data of various applications, that is, the number of daily active users, that is, the number of users who use a product or website every day, which is generally used to reflect the actual number of users, operation conditions, and the like of the website, the application, and the like. If the number of data tables in the database 120 is small, the user who performs the query may determine from which data tables the data should be queried. However, as the number of tables increases (for example, data tables in the millions), it is difficult for the user to determine which data tables should be used to obtain the information they want to query. Therefore, a data table retrieval system 150 is needed to retrieve some data tables for the user according to the query 140, for example, to return data tables related to the daily active user data to the user.

The data table retrieval system 150 may retrieve a target data table set 152 from the database 120 according to the query 140 and the data table summary 132. For example, the data table retrieval system 150 may determine the target data table set 152 according to the query 140 and the data table summary 132. Then, the data table retrieval system 150 may determine a target field set 154 from the target data table set 152 according to the query 140 and the field names 136. For example, the target data table set 152 may include 10 data tables, and the target field set 154 may include target fields for each of the 10 data tables. Finally, the data table retrieval system 150 may return the data table retrieval system 150 and the target data table set 152 as a retrieval result 160 to the user, and the user may determine required data tables and fields according to the retrieval result 160.

It should be understood that the architecture and functions in the example environment 100 are described for exemplary purposes only, without implying any limitation on the scope of the present disclosure. The embodiments of the present disclosure may also be applied to other environments with different structures and/or functions.

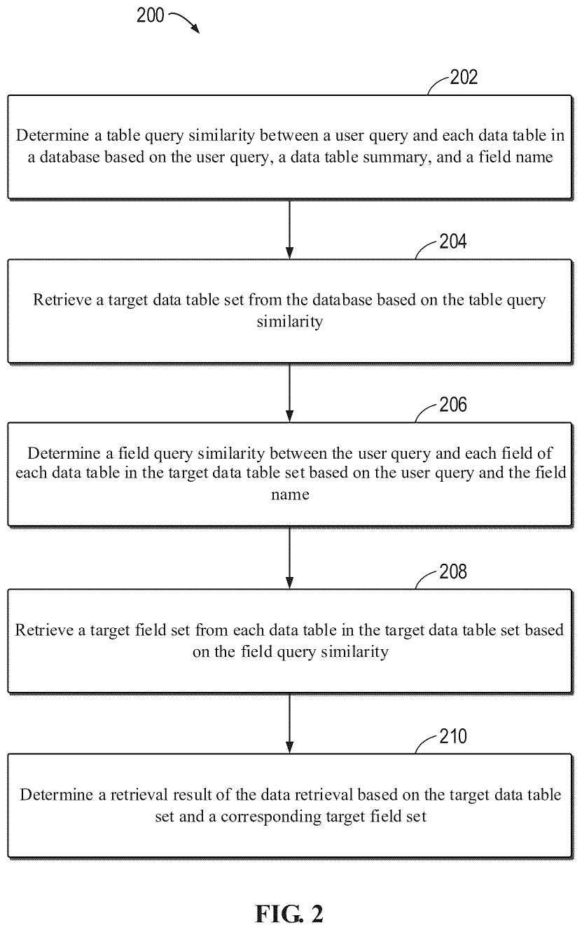

The process according to the embodiments of the present disclosure will be described in detail below with reference to FIG. 2 to FIG. 8. For ease of understanding, the specific data mentioned in the following description is exemplary and is not intended to limit the protection scope of the present disclosure. It can be understood that the embodiments described below may also include additional actions not shown and/or the shown actions may be omitted, and the scope of the present disclosure is not limited in this respect.

FIG. 2 illustrates a flowchart of a method 200 for data retrieval according to an embodiment of the present disclosure. At block 202, a table query similarity between a user query and each data table in a database may be determined based on the user query, a data table summary, and a field name. For example, referring to FIG. 1, the data table retrieval system 150 may determine a table query similarity between the user query 140 and each data table 130 in the database 120 based on the user query 140, the data table summary 132, and the field names 136.

At block 204, a target data table set may be retrieved from the database based on the table query similarity, where the target data table set includes data associated with the user query. For example, referring to FIG. 1, the data table retrieval system 150 may retrieve a target data table set 152 from the database 120 based on the table query similarity, where the target data table set 152 includes data associated with the user query 140.

At block 206, a field query similarity between the user query and each field of each data table in the target data table set may be determined based on the user query and the field name. For example, referring to FIG. 1, the data table retrieval system 150 may determine a field query similarity between the user query 140 and each field of each data table in the target data table set 152 based on the user query 140 and the field names 136.

At block 206, a target field set may be retrieved from each data table in the target data table set based on the field query similarity. For example, referring to FIG. 1, the data table retrieval system 150 may retrieve a target field set 154 from each data table in the target data table set 152 based on the field query similarity.

Therefore, according to the method 200 of the embodiment of the present disclosure, according to the solution of the embodiments of the present disclosure, when a user performs data retrieval, not only a data table retrieval result but also a corresponding field retrieval result can be returned, ensuring that the retrieval result better meets the needs of the user, providing the user with a higher-quality data retrieval experience, and being widely applicable and capable of supporting complex query requirements.

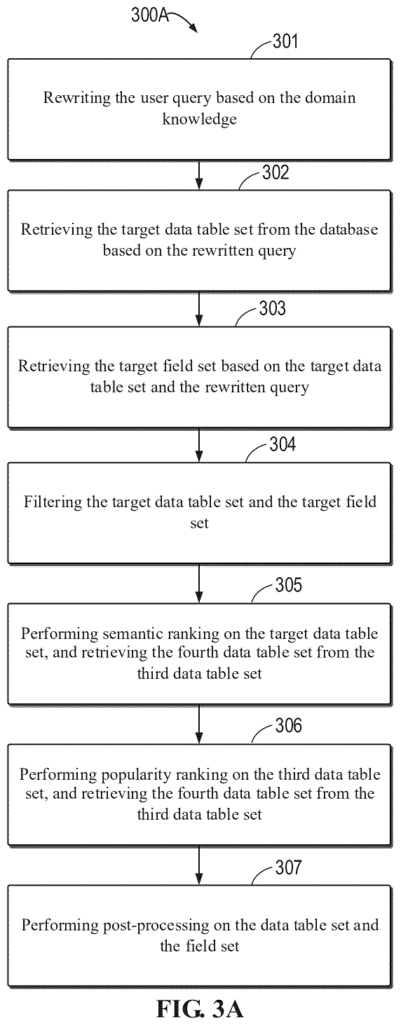

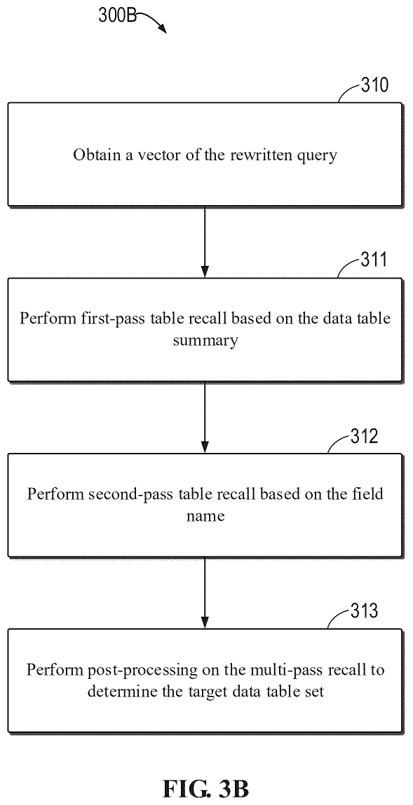

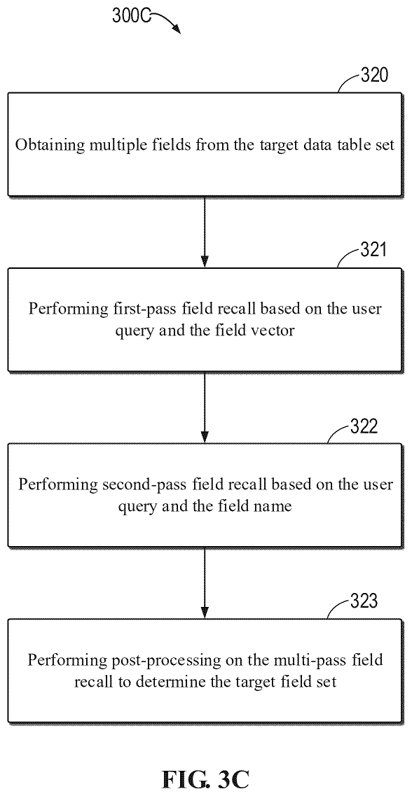

FIG. 3A illustrates a flowchart of a process 300A of data retrieval according to an embodiment of the present disclosure. As shown in FIG. 3A, at block 301, a user query may be rewritten based on domain knowledge. For example, as shown in FIG. 1, the data table retrieval system 150 may obtain a user query 140 (also referred to as a first query), and may rewrite the query 140 based on the domain knowledge to generate a rewritten query (also referred to as a second query), and use the rewritten query in subsequent processing. For example, if the user query is “What are the recent DAUs of various applications”, the user query may be rewritten as “What are the recent daily active users of various applications” according to the domain knowledge at the table level, that is, the DAU (Daily Active User) field has the same meaning as the daily active user field. In addition, the user query may also be rewritten according to knowledge at the global level or the service level. For example, if the user query is “What are the recent daily active users of the application AAA”, according to the knowledge at the service level, “application AAA” has the same meaning as “application BBB”, so the user query may be rewritten as “What are the recent daily active users of the application BBB”. In some embodiments, the user query may be rewritten based on a rule generated based on the domain knowledge. In some embodiments, the user query may be intelligently rewritten based on a pre-trained model incorporating the domain knowledge. By rewriting the user query based on the domain knowledge at different levels, inconsistency of query content caused by user habits can be avoided, thereby improving the relevance and accuracy of query results.

At block 302, a target data table set may be retrieved from the database based on the rewritten query. As shown in FIG. 1, the data table retrieval system 150 may retrieve the data tables 130 in the database 120 based on the rewritten query to obtain the target data table set 152. Retrieving a data table set from the database may also be referred to as recalling a data table set from the database. The process of recalling a data table set from the database will be described below with reference to FIG. 3B.

FIG. 3B illustrates a schematic diagram of a process 300B of recalling a data table set according to an embodiment of the present disclosure. As shown in FIG. 3B, at block 310, a vector of the rewritten query (hereinafter referred to as a query vector) may be obtained. In some embodiments, the query vector may be obtained using a pre-trained model. At block 311, first-pass recall of data tables may be performed based on the user query and the data table summary. In some embodiments, a data table set (also referred to as a first data table set) may be recalled from the database based on the similarity between the query vector and a summary vector generated using the data table summary. In some embodiments, the data table summary may be generated using the pre-trained model based on content information (for example, a table name, a field name, or field metadata) of the data table, and another pre-trained model may be used to process the data table summary to generate the summary vector, which is stored in the vector library.

At block 312, second-pass recall of data tables may be performed based on the user query and the field name. In some embodiments, a data table set (also referred to as a second data table set) may be recalled from the database based on similarity between a field vector of the field name and the query vector. For example, multiple field vectors of the data table may be obtained, and the field vectors may be generated in advance by processing field information (for example, a field name and/or field metadata) through the pre-trained model and stored in the vector library. In some embodiments, multiple similarities may be generated based on the multiple field vectors and the query vector, and similarity between the data table and the query vector may be determined based on the multiple similarities. For example, if the data table includes three fields: field A, field B, and field C, the similarity between field A and the query vector is 0.6, the similarity between field B and the query vector is 0.7, and the similarity between field C and the query vector is 0.8, the similarity between the data table and the query vector may be determined as (0.6+0.7+0.8)/3. It should be understood that the above method is only an example of determining the table similarity through the field similarity, and the embodiments of the present disclosure are not limited thereto.

At block 313, post-processing may be performed on the multi-pass recall to determine the target data table set (for example, the target data table set 152 shown in FIG. 1 or the target data table set in FIG. 3A). For example, the result of the first-pass table recall may be fused with the result of the second-pass table recall, and deduplication processing may be performed. In some embodiments, the first-pass data table recall and the second-pass data table recall may be fused according to a preset rule to obtain a predetermined number of data tables. For example, the first-pass data table recall may be given priority, and the second-pass data table recall may be used as a supplement to obtain a predetermined number (for example, 20) of data tables. For example, the second-pass data table recall may be given priority, and the first-pass data table recall may be used as a supplement to obtain a predetermined number of data tables. It should be understood that the two-pass data table recall shown here is only an example, and the embodiments of the present disclosure may also adopt one-pass data table recall, or perform expansion to adopt more-pass data table recall.

Referring back to FIG. 3A, as mentioned above, at block 302, the target data table set may be retrieved, and the process proceeds to block 303, where the target field set may be retrieved based on the target data table set and the rewritten query. As mentioned above, the embodiments of the present disclosure may retrieve a data table required by the user from the massive data table set for the user. However, the retrieved table may include a large number of fields, and the user still cannot quickly determine the required field. Therefore, the solution provided by the embodiments of the present disclosure may also retrieve the required field for the user. Retrieving the field set from the data table set may also be referred to as recalling the field set from the data table set. The process of recalling the field set will be described below with reference to FIG. 3C.

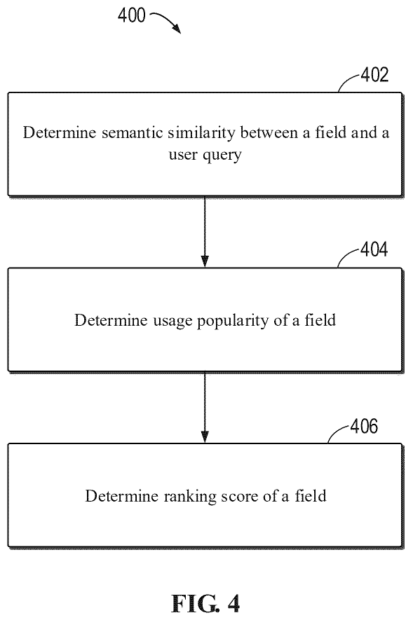

FIG. 3C illustrates a schematic diagram of a process 300C of recalling a field set according to an embodiment of the present disclosure. As shown in FIG. 3C, at block 320, multiple fields may be obtained from the target data table set. For example, if the target data table set may include 20 data tables, the K fields with the highest popularity in each data table may be obtained, that is, 20*K fields are obtained. At block 321, first-pass field recall may be performed based on the query vector (for example, the query vector described in FIG. 3B) and the field vector. For example, the first-pass field recall may be performed by calculating a vector similarity between the query vector and the field vector. In some embodiments, the field vector may be generated by pre-training the field name. In addition, data popularity may also be applied to the field recall stage, which will be described below with reference to FIG. 4.

At block 322, second-pass field recall may be performed based on the user query and the field name. For example, the field recall may be performed based on a literal matching degree (for example, a text similarity) between the user query and the field. In some embodiments, the user query may be rewritten according to the domain knowledge, and then the literal matching degree between the user query and the field may be calculated. At block 323, post-processing may be performed on the multi-pass field recall to determine the target field set. For example, the result of the first-pass field recall may be fused with the result of the second-pass field recall, and deduplication processing may be performed. In some embodiments, a predetermined number (for example, 20 for each data table) of fields may be obtained according to a preset rule. For example, the first-pass field recall may be given priority, and the second-pass field recall may be used as a supplement to obtain the predetermined number of fields. In addition, the second-pass field recall may be given priority, and the first-pass field recall may be used as a supplement to obtain the predetermined number of fields. It should be understood that the two-pass field recall shown here is only an example, and the embodiments of the present disclosure may also adopt one-pass field recall, or perform expansion to adopt more-pass field recall.

Referring back to FIG. 3A, as mentioned above, at block 303, the target field set may be retrieved, and the process proceeds to block 304, where the target data table set and the target field set may be filtered. For example, the status of each data table in the target data table set may be obtained, and if the data table is in an unretained status, the data table and its fields may be filtered out. In some embodiments, whether the data table is in the retained status may be determined by determining a data update date in the data table. In addition, the metadata of each field in the target field set may be obtained to determine whether to filter out the field. For example, if the metadata of the field cannot be queried, it may be determined to filter out the field.

At block 305, semantic ranking may be performed on the target data table set, and a third data table set may be retrieved from the target data table set. For example, each data table in the target data table set may be combined with multiple corresponding fields in the target field set to generate prompt content for each data table, and an online ranking model may be requested to score each data table. In some embodiments, the online ranking model may be a pre-trained language model.

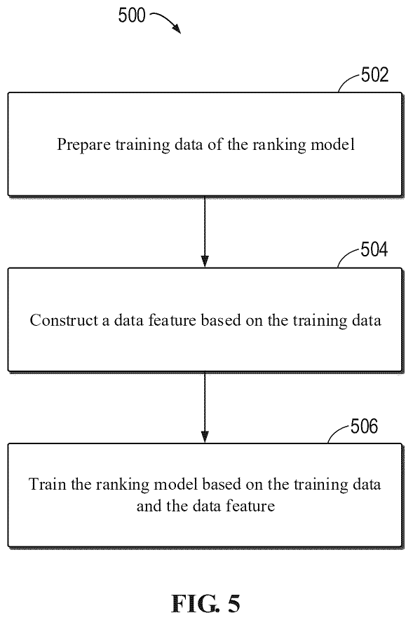

At block 306, a fourth data table set may be retrieved from the third data table set based on the table statistical data. In some embodiments, each data table in the third data table set may be scored based on the table statistical data using a popularity ranking model (for example, a machine learning model or a deep learning model), and the fourth data table set may be retrieved according to the score. For example, the table statistical data may include but is not limited to: historical retrieval volume of the data table, historical query volume of the data table, retrieval volume in a certain period of time, query volume in a certain period of time, and other information, which can reflect the usage popularity information of the data table. The retrieval volume may reflect the number of times the data table is presented to the user, and the query volume may reflect the number of times the user queries the data table, so the click-through rate may be constructed as click-through rate=retrieval volume/query volume to reflect the popularity of the data table. In addition, other table statistical data or data constructed using the table statistical data may be used as features for scoring and ranking by the machine learning model, which is not limited in the present disclosure. In some embodiments, other data may also be used for scoring, for example, a recall route identifier (that is, a route from which the data table is recalled), a semantic ranking score, a semantic ranking order, and the like. The training process of the ranking model will be described below with reference to FIG. 5.

At block 307, post-processing may be performed on the data table set and the field set. In some embodiments, a date field set of each data table in the fourth data table set may be obtained. In some embodiments, a popular field set of each data table in the fourth data table set may be determined based on the field statistical data. In addition, in some embodiments, a combined field set may be generated based on the date field set, the popular field set, and the target field set, and the combined field set may be returned to the user.

FIG. 4 illustrates a schematic diagram of a process 400 of field recall using data popularity according to an embodiment of the present disclosure. As shown in FIG. 4, at block 402, a semantic similarity between a field and a user query may be determined. For example, the semantic similarity may be determined according to a field vector and a text vector. It should be understood that the user query may be a rewritten user query. In addition, the text similarity should be distinguished from the semantic similarity. For example, the text similarity between “DAU” and “daily active user” is zero, but they have the same semantic meaning, that is, the number of daily active users, and the semantic similarity is very high. At block 404, a usage popularity of the field may be determined. For example, the usage popularity of the field may be represented by the usage popularity in the last 60 days (after normalization). In the field recall stage, when faced with fields with high text matching degrees (for example, many fields are called “lead rate” or “XX lead rate”), the introduction of the field popularity data is the key to distinguishing these fields.

At block 406, a ranking score of the field may be determined. For example, the field ranking score may be calculated by formula (1), and the fields with the top scores may be selected:

$$score = a * semantic\_score + b * hot\_score \qquad ( 1 )$$

where semantic_score is a similarity score calculated based on the query vector and the field vector, hot_score is a popularity score of the field (for example, the usage popularity in the last 60 days), and parameters a and b are weights. In some embodiments, the parameters a and b are configured by experts and meet the characteristics of the service itself. In some embodiments, the optimal values of the parameters a and b are obtained by a grid search strategy, which ensures the accuracy and effectiveness of the score.

Therefore, by fusing the popularity information for field recall, not only the semantic relevance between the field and the user query is fully considered, but also the actual usage popularity of the field is considered. Especially when there are multiple fields with similar semantics in the same data table, the usage popularity becomes an effective distinguishing means.

FIG. 5 illustrates a flowchart of a process 500 of training a ranking model according to an embodiment of the present disclosure. In the recall process of data tables, when faced with multiple data tables with similar content (for example, multiple tables are all related to “turnover”), the introduction of user habits is crucial to optimizing the user experience. At block 502, the training data of the ranking model is prepared. In some embodiments, the training data may include the table statistical data and the semantic ranking score. In addition, the recall route identifier of the data table (that is, a route from which the data table is recalled), the semantic ranking order, the long/medium/short-term usage popularity of the data table, and the like may also be used as the training data. As mentioned above, the usage popularity may be constructed using the table statistical data related to the table usage volume. At block 504, the data feature is constructed based on the training data. For example, a missing value may be processed, feature normalization may be performed, noise point processing may be performed, feature continuous value analysis may be performed, and correlation analysis between features may be performed. At block 506, the ranking model is trained based on the training data and the data feature. In some embodiments, the ranking model may be a machine learning model or a deep learning model.

Therefore, in a final ranking stage of the data table, ranking is not only performed depending on semantic relevance, but a ranking model incorporating a plurality of features such as data usage popularity is used for ranking. The ranking model combines multi-dimensional features such as a semantic ranking score, a ranking position, and long/medium/short-term usage popularity of the data table, to implement accurate ranking of the recalled data table.

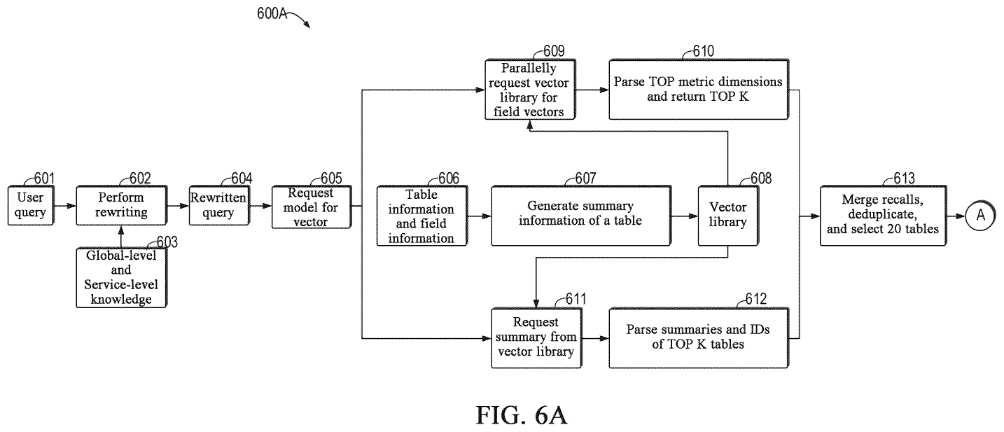

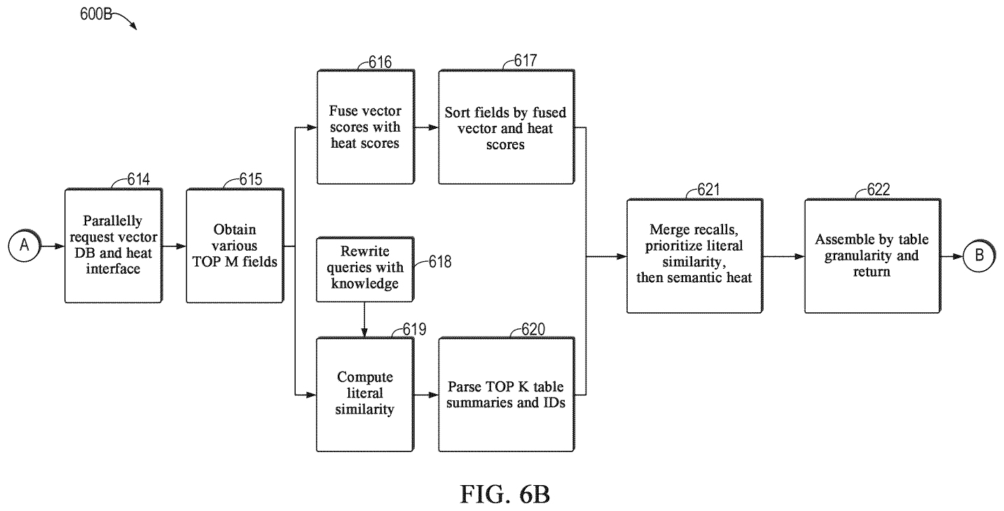

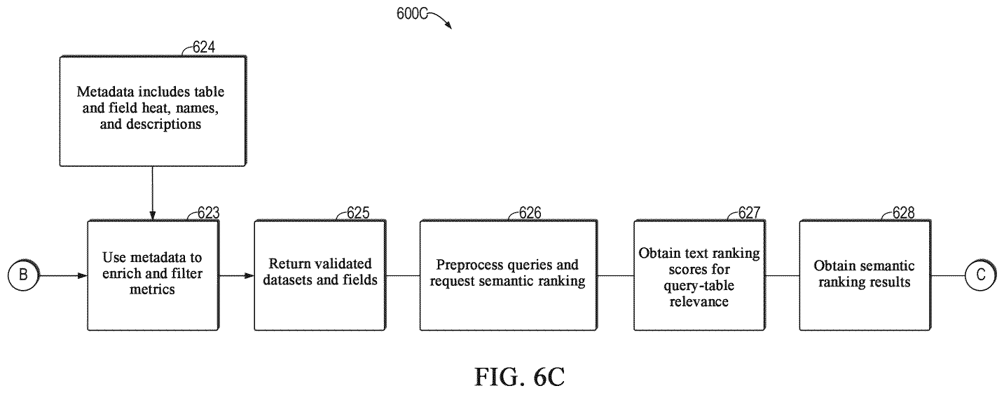

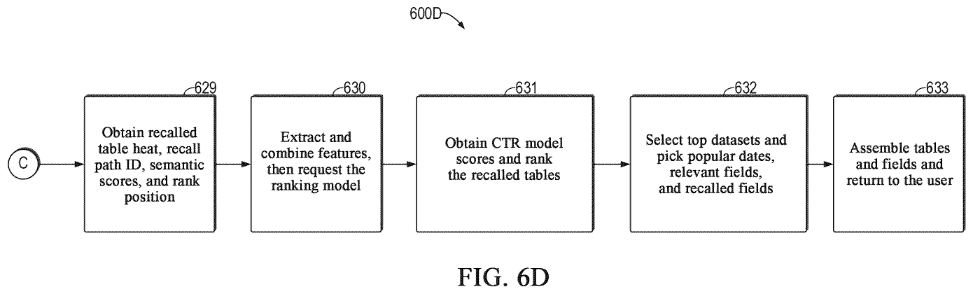

FIG. 6A-FIG. 6D jointly illustrate schematic diagrams of processes 600A-600D of data table retrieval and field retrieval according to an embodiment of the present disclosure. Referring to FIG. 6A, at block 601, a user query is input. At block 602, query rewriting may be performed based on knowledge. Global-level knowledge and service-level knowledge may be obtained at block 603. At block 604, a rewritten query may be generated. In some embodiments, the query rewriting may be performed based on a rule generated based on knowledge. In some embodiments, the query may be intelligently rewritten using a model trained with knowledge. At block 606, table information and field information may be obtained. At block 607, summary information of a table may be generated using a pre-trained generative model, and a table vector may be generated based on the summary information of the table and a field vector may be generated based on the field information. At block 608, the table vector and the field vector may be stored in a vector library.

At block 609, the vector library may be requested in parallel to obtain the field vector. For example, the popular field information of each table is requested from the vector library. At block 610, the popular field information may be parsed, aggregated into data table features for ranking, and finally the table IDs of TOP K are returned to complete the first-pass table recall. For example, the similarity between a table and the query vector may be determined based on the similarity between a field and the query vector. At block 611, the vector library may be requested to obtain the vector of the table summary. At block 612, the TOP K table summaries and table IDs recalled may be parsed to complete the second-pass table recall. For example, the recall may be performed by the similarity between the query vector and the vector of the table summary. Proceeding to block 613, the two-pass recall is fused, and 20 data tables are obtained through deduplication. It should be understood that other number of data tables may also be obtained. The process 600B of table retrieval and field retrieval according to the embodiment of the present disclosure will be continuously described below with reference to FIG. 6B.

As shown in FIG. 6B, at block 614 (following block 613 in FIG. 6A), a vector database and a data popularity interface may be requested in parallel. For example, the field vector may be obtained from the vector database interface, and the field popularity information may be obtained from the data popularity interface. At block 615, various TOP M fields of the recalled table may be obtained. For example, the TOP 10 fields in the recalled table may be obtained. At block 616, the vector retrieval score may be fused with the field popularity score. For example, the vector retrieval score may be calculated based on the similarity between the query vector and the field vector, and the field popularity may be the usage popularity of the field in the last 60 days. At block 617, the fields may be ranked according to the score after the vector retrieval score is fused with the field popularity, to complete the first-pass recall. For example, the fields may be ranked according to the fused score of each field. At block 618, query rewriting is performed based on the knowledge at the data set level. At block 619, the literal similarity between the candidate field and the user query may be calculated. For example, the literal similarity may be determined according to the text matching degree between the candidate field and the user query. At block 620, a result satisfying the threshold of the literal similarity may be set for priority recall to complete the second-pass recall. For example, the priority recall may be set when the literal similarity is greater than 90%. At block 621, the results of the two-pass recall may be fused, and the result with high literal similarity may be preferentially returned, followed by the result of the semantic popularity fusion. At block 622, the data table and the field are assembled and returned according to the data table level. For example, the recalled table and its corresponding recalled field may be determined and returned. The process 600C of data table retrieval and field retrieval according to the embodiment of the present disclosure will be continuously described below with reference to FIG. 6C.

As shown in FIG. 6C, at block 623 (following block 622 in FIG. 6B), the metadata is invoked to enrich the entity information and filter out illegal indicators. For example, the metadata, as shown in block 624, includes the popularity information of the data table, and the popularity, name, description, and the like of the field. At block 625, a legal verified data set and field are returned. For example, the recalled field metadata (such as an expression, a description, and the like) may be queried to enrich the returned data, and a field whose metadata cannot be queried may be filtered out. At block 626, the text of the user query and the table may be pre-processed and composed into the prompt content, and an online semantic ranking model may be requested to score. In some embodiments, the prompt content may be processed using a pre-trained generative model to generate the score. At block 627, the text ranking score of the relevance between the user query and the table may be obtained. At block 628, the semantic ranking result may be obtained. For example, the table may be ranked according to the semantic score, and a predetermined threshold of data tables may be returned. The process 600D of table retrieval and field retrieval according to the embodiment of the present disclosure will be continuously described below with reference to FIG. 6D.

As shown in FIG. 6D, at block 629 (following block 628 in FIG. 6B), the popularity information, the table recall route identifier, the semantic scoring information, and the ranking position of the recalled data table may be obtained. For example, the popularity information may be the click-through rate data of the table. At block 630, feature extraction may be performed and the extracted features may be combined, and the click-through rate model may be requested in parallel. At block 631, the ranking score of the click-through rate model may be obtained and the recalled data table may be ranked. For example, the click-through rate model may predict the click-through rate score of each data table, and the data table may be ranked according to the click-through rate score. At block 632, the data table ranking in the top order may be selected, and the popular date field, the popular related field, and the recalled field in the data set may be selected according to the popularity. At block 633, the data table and the field are assembled according to the data table level and returned to the user.

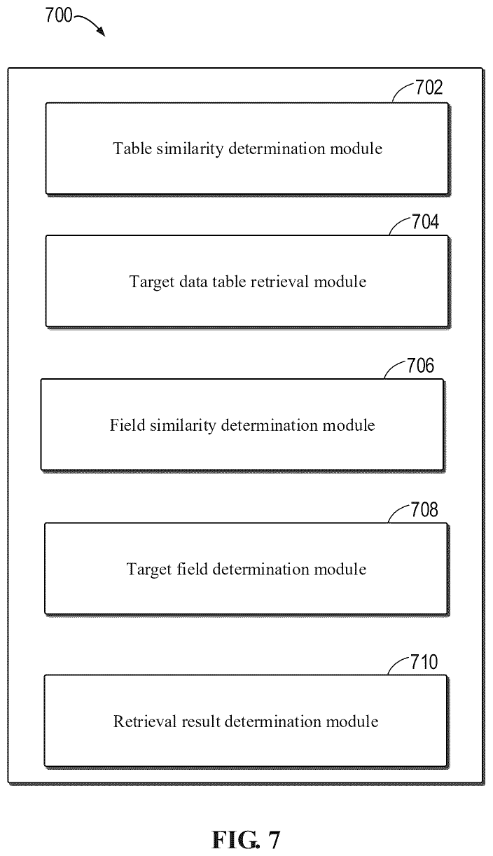

FIG. 7 illustrates a block diagram of an apparatus 700 for data retrieval according to some embodiments of the present disclosure. The apparatus 700 includes a table similarity determination module 702 configured to determine a table query similarity between a user query and each data table in a database based on the user query, a data table summary, and a field name. The apparatus 700 further includes a target data table retrieval module 704 configured to retrieve a target data table set from the database based on the table query similarity, where the target data table set includes data associated with the user query. The apparatus 700 further includes a field similarity determination module 706 configured to determine a field query similarity between the user query and each field of each data table in the target data table set based on the user query and the field name. The apparatus 700 further includes a target field determination module 708 configured to retrieve a target field set from each data table in the target data table set based on the field query similarity. In addition, the apparatus 700 further includes a retrieval result determination module 710 configured to determine a retrieval result of the data retrieval based on the target data table set and a corresponding target field set.

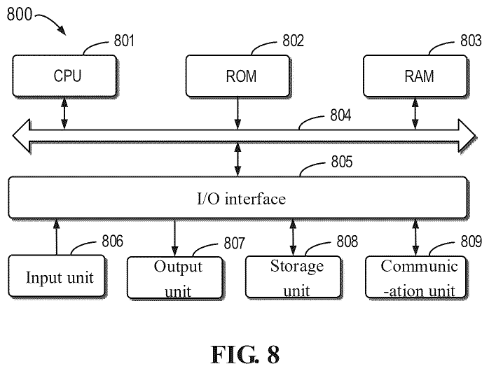

FIG. 8 illustrates a block diagram of an electronic device 800 according to some embodiments of the present disclosure. FIG. 8 illustrates a block diagram of an electronic device 800 according to some embodiments of the present disclosure. The device 800 may be a device or an apparatus described in the embodiments of the present disclosure. As shown in FIG. 8, the device 800 includes a central processing unit (CPU) and/or a graphics processing unit (GPU) 801, which may perform various suitable actions and processes according to computer program instructions stored in a read-only memory (ROM) 802 or computer program instructions loaded from a storage unit 808 into a random access memory (RAM) 803. The RAM 803 may further store various programs and data required for the operation of the device 800. The CPU/GPU 801, the ROM 802, and the RAM 803 are connected to each other through a bus 804. An input/output (I/O) interface 805 is also connected to the bus 804. Although not shown in FIG. 8, the device 800 may further include a coprocessor.

Multiple components in the device 800 are connected to the I/O interface 805, including: an input unit 806, such as a keyboard, a mouse, etc.; an output unit 807, such as various types of displays, speakers, etc.; a storage unit 808, such as a magnetic disk, an optical disk, etc.; and a communication unit 809, such as a network card, a modem, a wireless communication transceiver, etc. The communication unit 809 allows the device 800 to exchange information/data with other devices through a computer network such as the Internet and/or various telecommunication networks.

The various methods or processes described above may be performed by the CPU/GPU 801. For example, in some embodiments, the method may be implemented as a computer software program, which is tangibly included in a machine-readable medium, such as the storage unit 808. In some embodiments, part or all of the computer program may be loaded and/or installed on the device 800 via the ROM 802 and/or the communication unit 809. When the computer program is loaded into the RAM 803 and executed by the CPU/GPU 801, one or more steps or actions in the methods or processes described above may be executed.

In some embodiments, the methods and processes described above may be implemented as a computer program product. The computer program product may include a computer-readable storage medium having computer-readable program instructions for performing various aspects of the present disclosure.

The computer-readable storage medium may be a tangible device that can hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical coding device, such as a punched card or a groove and bump structure having instructions stored thereon, and any suitable combination thereof. The computer-readable storage medium used herein is not interpreted as a transient signal itself, such as a radio wave or other freely propagating electromagnetic wave, an electromagnetic wave propagating through a waveguide or other transmission medium (for example, an optical pulse through an optical fiber cable), or an electrical signal transmitted through a wire.

The computer-readable program instructions described herein may be downloaded from a computer-readable storage medium to various computing/processing devices, or may be downloaded to an external computer or an external storage device through a network, such as the Internet, a local area network, a wide area network, and/or a wireless network. The network may include a copper transmission cable, an optical fiber transmission, a wireless transmission, a router, a firewall, a switch, a gateway computer, and/or an edge server. The network adapter card or network interface in each computing/processing device receives computer-readable program instructions from the network and forwards them for storage in the computer-readable storage medium in the respective computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, including object-oriented programming languages and conventional procedural programming languages. The computer-readable program instructions may be executed entirely on a user's computer, partly on a user's computer, as a stand-alone software package, partly on a user's computer and partly on a remote computer, or entirely on a remote computer or server. In the case of the remote computer, the remote computer may be connected to the user's computer through any kind of network, including a local area network (LAN) or a wide area network (WAN), or may be connected to an external computer (for example, via the Internet using an Internet service provider). In some embodiments, an electronic circuit, such as a programmable logic circuit, a field programmable gate array (FPGA), or a programmable logic array (PLA), is customized by using state information of the computer-readable program instructions, and the electronic circuit may execute the computer-readable program instructions, thereby implementing various aspects of the present disclosure.

These computer-readable program instructions may be provided to a processing unit of a general-purpose computer, a special-purpose computer, or other programmable data processing apparatus to produce a machine, so that the instructions, when executed by the processing unit of the computer or other programmable data processing apparatus, produce an apparatus for implementing the functions/acts specified in one or more blocks of the flowcharts and/or block diagrams. These computer-readable program instructions may also be stored in a computer-readable storage medium. These instructions cause a computer, a programmable data processing apparatus, and/or other devices to work in a specific way. Therefore, the computer-readable medium having instructions stored thereon includes an article of manufacture, which includes instructions for implementing various aspects of the functions/acts specified in one or more blocks of the flowcharts and/or block diagrams.

The computer-readable program instructions may also be loaded onto a computer, other programmable data processing apparatus, or other device, so that a series of operation steps are performed on the computer, other programmable data processing apparatus, or other device to produce a computer-implemented process, thereby causing the instructions executed on the computer, other programmable data processing apparatus, or other device to implement the functions/acts specified in one or more blocks of the flowcharts and/or block diagrams.

The flowcharts and block diagrams in the drawings show possible architectures, functions and operations of the device, method and computer program product according to multiple embodiments of the present disclosure. In this regard, each block in the flowcharts or block diagrams may represent a module, a program segment, or part of instructions, including one or more executable instructions for implementing specified logical functions. In some alternative implementations, the functions marked in the blocks may occur in an order different from those marked in the drawings. For example, two consecutive blocks may actually be executed substantially in parallel, and sometimes may be executed in a reverse order, depending on the functions involved. It is also to be noted that each block in the block diagrams and/or flowcharts, and a combination of blocks in the block diagrams and/or flowcharts, may be implemented by a dedicated hardware-based system for executing specified functions or actions, or may be implemented by a combination of dedicated hardware and computer instructions.

Various embodiments of the present disclosure have been described above, and the above description is exemplary, not exhaustive, and is not limited to the disclosed embodiments. Many modifications and changes are obvious to those of ordinary skill in the art without departing from the scope and spirit of the described embodiments. The selection of terms used herein is intended to best explain the principles, practical applications, or technical improvements to the technology in the market of the embodiments, or to enable other ordinary skill in the art to understand the embodiments disclosed herein.

Some example implementations of the subject matter described herein are listed below.

Example 1. A method for data retrieval, including:
determining a table query similarity between a user query and each data table in a database based on the user query, a data table summary, and a field name;
retrieving a target data table set from the database based on the table query similarity, the target data table set including data associated with the user query;
determining a field query similarity between the user query and each field of each data table in the target data table set based on the user query and the field name;
retrieving a target field set from each data table in the target data table set based on the field query similarity; and
determining a retrieval result of the data retrieval based on the target data table set and the corresponding target field set.

Example 2. The method of example 1, where retrieving the target data table set from the database includes:
retrieving a first data table set from the database based on the user query and the data table summary;
retrieving a second data table set from the database based on the user query and the field name; and
determining the target data table set based on the first data table set and the second data table set.

Example 3. The method of examples 1-2, where retrieving the target data table set from the database includes:
generating a query vector of the user query through a pre-trained model;
obtaining a summary vector of the data table summary from a vector library, the summary vector being generated through the pre-trained model;
retrieving a first data table set from the database by determining a vector similarity between the query vector and the summary vector;
obtaining a field vector of the field name from the vector library, the field vector being generated through the pre-trained model;
retrieving a second data table set from the database by determining a vector similarity between the query vector and the field vector; and
determining the target data table set by performing deduplication and fusion on the first data table set and the second data table set.

Example 4. The method of examples 1-3, where retrieving the target field set from each data table in the target data table set includes:
retrieving a first field set from each data table in the target data table set based on the user query and the field name;
retrieving a second field set from each data table in the target data table set based on the user query and a field vector of the field name; and
determining the target field set of each data table in the target data table set based on the first field set and the second field set.

Example 5. The method of examples 1-4, where retrieving the target field set from each data table in the target data table set includes:
generating a rewritten user query based on domain knowledge associated with the user query;
retrieving the first field set from each data table in the target data table set by determining a literal similarity between the rewritten user query and the field name;
generating a query vector of the user query through a pre-trained model;
retrieving the second field set from each data table in the target data table set by determining a vector similarity between the query vector and the field vector; and
determining the target field set by performing deduplication and fusion on the first field set and the second field set based on a predefined rule.

Example 6. The method of examples 1-5, where retrieving the second field set from each data table in the target data table set further includes:
determining a field heat based on field statistical data; and
retrieving the second field set based on the vector similarity and the field heat.

Example 7. The method of examples 1-6, further including:
obtaining domain knowledge associated with the user query; and
generating a rewritten user query based on the user query and the domain knowledge.

Example 8. The method of examples 1-7, further including:
generating prompt information based on the user query and the target data table set;
generating a semantic ranking score of the target data table set using a pre-trained model based on the prompt information; and
retrieving a third data table set from the target data table set based on the semantic ranking score.

Example 9. The method of examples 1-8, further including:
determining a heat ranking score of the third data table set based on table statistical data of each data table in the third data table set; and
retrieving a fourth data table set from the third data table set based on the heat ranking score.

Example 10. The method of examples 1-9, further including:
obtaining a date field set of each data table in the fourth data table set;
determining a popular field set of each data table in the fourth data table set based on the field statistical data; and
generating a combined field set based on the date field set, the popular field set, and the target field set.

Example 11. An apparatus for data retrieval, including:
a table similarity determination module configured to determine a table query similarity between a user query and each data table in a database based on the user query, a data table summary, and a field name;
a target data table retrieval module configured to retrieve a target data table set from the database based on the table query similarity, the target data table set including data associated with the user query;
a field similarity determination module configured to determine a field query similarity between the user query and each field of each data table in the target data table set based on the user query and the field name;
a target field determination module configured to retrieve a target field set from each data table in the target data table set based on the field query similarity; and
a retrieval result determination module configured to determine a retrieval result of the data retrieval based on the target data table set and the corresponding target field set.

Example 12. The apparatus of example 11, where the target data table retrieval module includes:
a first data table set retrieval module configured to retrieve a first data table set from the database based on the user query and the data table summary;
a second data table set retrieval module configured to retrieve a second data table set from the database based on the user query and the field name; and
a target data table set determination module configured to determine the target data table set based on the first data table set and the second data table set.

Example 13. The apparatus of examples 11-12, where the target data table retrieval module includes:
a query vector generation module configured to generate a query vector of the user query through a pre-trained model;
a summary vector generation module configured to obtain a summary vector of the data table summary from a vector library, the summary vector being generated through the pre-trained model;
a first data table set second retrieval module configured to retrieve a first data table set from the database by determining a vector similarity between the query vector and the summary vector;
a field vector determination module configured to obtain a field vector of the field name from the vector library, the field vector being generated through the pre-trained model;
a second data table set second retrieval module configured to retrieve a second data table set from the database by determining a vector similarity between the query vector and the field vector; and
a target data table set second determination module configured to determine the target data table set by performing deduplication and fusion on the first data table set and the second data table set.

Example 14. The apparatus of examples 11-13, where retrieving the target field set from each data table in the target data table set includes:
a first field set retrieval module configured to retrieve a first field set from each data table in the target data table set based on the user query and the field name;
a second field set retrieval module configured to retrieve a second field set from each data table in the target data table set based on the user query and a field vector of the field name; and
a target field set determination module configured to determine the target field set of each data table in the target data table set based on the first field set and the second field set.

Example 15. The apparatus of examples 11-14, where retrieving the target field set from each data table in the target data table set includes:
a user query rewriting module configured to generate a rewritten user query based on domain knowledge associated with the user query;
a first field set second module configured to retrieve the first field set from each data table in the target data table set by determining a literal similarity between the rewritten user query and the field name;
a query vector generation module configured to generate a query vector of the user query through a pre-trained model;
a second field set second retrieval module configured to retrieve the second field set from each data table in the target data table set by determining a vector similarity between the query vector and the field vector; and
a target field set second determination module configured to determine the target field set by performing deduplication and fusion on the first field set and the second field set based on a predefined rule.

Example 16. The apparatus of examples 11-15, where the second field set second retrieval module further includes:
a field heat determination module configured to determine a field heat based on field statistical data; and
a second field set third retrieval module configured to retrieve the second field set based on the vector similarity and the field heat.

Example 17. The apparatus of examples 11-16, further including:
a domain knowledge obtaining module configured to obtain domain knowledge associated with the user query; and
a rewritten query generation module configured to generate a rewritten user query based on the user query and the domain knowledge.

Example 18. The apparatus of examples 11-17, the apparatus further including:
a prompt information generation module configured to generate prompt information based on the user query and the target data table set;
a semantic score generation module configured to generate a semantic ranking score of the target data table set using a pre-trained model based on the prompt information; and
a third data table set retrieval module configured to retrieve a third data table set from the target data table set based on the semantic ranking score.

Example 19. The apparatus of examples 11-18, the apparatus further including:
a heat score generation module configured to determine a heat ranking score of the third data table set based on table statistical data of each data table in the third data table set; and
a fourth data table set retrieval module configured to retrieve a fourth data table set from the third data table set based on the heat ranking score.

Example 20. The apparatus of Examples 11-19, the apparatus further including:
a date field set obtaining module configured to obtain a date field set of each data table in the fourth data table set;
a popular field set obtaining module configured to determine a popular field set of each data table in the fourth data table set based on the field statistical data; and
a combined field set generation module configured to generate a combined field set based on the date field set, the popular field set, and the target field set.

Example 21. An electronic device, including:
a processor; and
a memory coupled to the processor, the memory having instructions stored thereon, the instructions, when executed by the processor, causing the electronic device to perform acts, the acts including:
determining a table query similarity between a user query and each data table in a database based on the user query, a data table summary, and a field name;
retrieving a target data table set from the database based on the table query similarity, the target data table set including data associated with the user query;
determining a field query similarity between the user query and each field of each data table in the target data table set based on the user query and the field name;
retrieving a target field set from each data table in the target data table set based on the field query similarity; and
determining a retrieval result of the data retrieval based on the target data table set and the corresponding target field set.

Example 22. The electronic device of claim 21, where retrieving the target data table set from the database includes:
retrieving a first data table set from the database based on the user query and the data table summary;
retrieving a second data table set from the database based on the user query and the field name; and
determining the target data table set based on the first data table set and the second data table set.

Example 23. The electronic device of claims 21-22, where retrieving the target data table set from the database includes:
generating a query vector of the user query through a pre-trained model;
obtaining a summary vector of the data table summary from a vector library, the summary vector being generated through the pre-trained model;
retrieving a first data table set from the database by determining a vector similarity between the query vector and the summary vector;
obtaining a field vector of the field name from the vector library, the field vector being generated through the pre-trained model;
retrieving a second data table set from the database by determining a vector similarity between the query vector and the field vector; and
determining the target data table set by performing deduplication and fusion on the first data table set and the second data table set.

Example 24. The electronic device of claims 21-23, where retrieving the target field set from each data table in the target data table set includes:
retrieving a first field set from each data table in the target data table set based on the user query and the field name;
retrieving a second field set from each data table in the target data table set based on the user query and a field vector of the field name; and
determining the target field set of each data table in the target data table set based on the first field set and the second field set.

Example 25. The electronic device of claims 21-24, where retrieving the target field set from each data table in the target data table set includes:
generating a rewritten user query based on domain knowledge associated with the user query;
retrieving the first field set from each data table in the target data table set by determining a literal similarity between the rewritten user query and the field name;
generating a query vector of the user query through a pre-trained model;
retrieving the second field set from each data table in the target data table set by determining a vector similarity between the query vector and the field vector; and
determining the target field set by performing deduplication and fusion on the first field set and the second field set based on a predefined rule.

Example 26. The electronic device of claims 21-25, where retrieving the second field set from each data table in the target data table set further includes:
determining a field heat based on field statistical data; and
retrieving the second field set based on the vector similarity and the field heat.

Example 27. The electronic device of claims 21-26, the acts further including:
obtaining domain knowledge associated with the user query; and
generating a rewritten user query based on the user query and the domain knowledge.

Example 28. The electronic device of claims 21-27, the acts further including:
generating prompt information based on the user query and the target data table set;
generating a semantic ranking score of the target data table set using a pre-trained model based on the prompt information; and
retrieving a third data table set from the target data table set based on the semantic ranking score.

Example 29. The electronic device of claims 21-28, the acts further including:
determining a heat ranking score of the third data table set based on table statistical data of each data table in the third data table set; and
retrieving a fourth data table set from the third data table set based on the heat ranking score.

Example 30. The electronic device of claims 21-29, the acts further including:
obtaining a date field set of each data table in the fourth data table set;
determining a popular field set of each data table in the fourth data table set based on the field statistical data; and
generating a combined field set based on the date field set, the popular field set, and the target field set.

Example 31. A computer-readable storage medium having one or more computer instructions stored thereon, where the one or more computer instructions are executed by a processor to implement the method of any one of examples 1 to 10.

Example 32. A computer program product, which is tangibly stored on a computer-readable medium and includes computer-executable instructions, the computer-executable instructions, when executed by a device, causing the device to perform the method of any one of examples 1 to 10.

Although the present disclosure has been described in language specific to structural features and/or logical acts of methods, it should be understood that the subject matter defined in the appended claims is not necessarily limited to the specific features or acts described above. Rather, the specific features and acts described above are only exemplary forms for implementing the claims.

I/We claim:

1. A method for data retrieval, comprising:
determining a table query similarity between a user query and each data table in a database based on the user query, a data table summary, and a field name;
retrieving a target data table set from the database based on the table query similarity, the target data table set comprising data associated with the user query;
determining a field query similarity between the user query and each field of each data table in the target data table set based on the user query and the field name;
retrieving a target field set from each data table in the target data table set based on the field query similarity; and
determining a retrieval result of the data retrieval based on the target data table set and the corresponding target field set.

2. The method of claim 1, wherein retrieving the target data table set from the database comprises:
retrieving a first data table set from the database based on the user query and the data table summary;
retrieving a second data table set from the database based on the user query and the field name; and
determining the target data table set based on the first data table set and the second data table set.

3. The method of claim 2, wherein retrieving the target data table set from the database comprises:
generating a query vector of the user query through a pre-trained model;
obtaining a summary vector of the data table summary from a vector library, the summary vector being generated through the pre-trained model;
retrieving the first data table set from the database by determining a vector similarity between the query vector and the summary vector;
obtaining a field vector of the field name from the vector library, the field vector being generated through the pre-trained model;
retrieving the second data table set from the database by determining a vector similarity between the query vector and the field vector; and
determining the target data table set by performing deduplication and fusion on the first data table set and the second data table set.

4. The method of claim 1, wherein retrieving the target field set from each data table in the target data table set comprises:
retrieving a first field set from each data table in the target data table set based on the user query and the field name;
retrieving a second field set from each data table in the target data table set based on the user query and a field vector of the field name; and
determining the target field set of each data table in the target data table set based on the first field set and the second field set.

5. The method of claim 4, wherein retrieving the target field set from each data table in the target data table set comprises:
generating a rewritten user query based on domain knowledge associated with the user query;
retrieving the first field set from each data table in the target data table set by determining a literal similarity between the rewritten user query and the field name;
generating a query vector of the user query through a pre-trained model;
retrieving the second field set from each data table in the target data table set by determining a vector similarity between the query vector and the field vector; and
determining the target field set by performing deduplication and fusion on the first field set and the second field set based on a predefined rule.

6. The method of claim 5, wherein retrieving the second field set from each data table in the target data table set further comprises:
determining a field heat based on field statistical data; and
retrieving the second field set based on the vector similarity and the field heat.

7. The method of claim 1, further comprising:
obtaining domain knowledge associated with the user query; and
generating a rewritten user query based on the user query and the domain knowledge.

8. The method of claim 1, further comprising:
generating prompt information based on the user query and the target data table set;
generating a semantic ranking score of the target data table set using a pre-trained model based on the prompt information; and
retrieving a third data table set from the target data table set based on the semantic ranking score.

9. The method of claim 8, further comprising:
determining a heat ranking score of the third data table set based on table statistical data of each data table in the third data table set; and
retrieving a fourth data table set from the third data table set based on the heat ranking score.

10. The method of claim 9, further comprising:
obtaining a date field set of each data table in the fourth data table set;
determining a popular field set of each data table in the fourth data table set based on the field statistical data; and
generating a combined field set based on the date field set, the popular field set, and the target field set.

11. An electronic device, comprising:
a processor; and
a memory coupled to the processor, the memory having instructions stored thereon, the instructions, when executed by the processor, causing the electronic device:
determine a table query similarity between a user query and each data table in a database based on the user query, a data table summary, and a field name;
retrieve a target data table set from the database based on the table query similarity, the target data table set comprising data associated with the user query;
determine a field query similarity between the user query and each field of each data table in the target data table set based on the user query and the field name;
retrieve a target field set from each data table in the target data table set based on the field query similarity; and
determine a retrieval result of the data retrieval based on the target data table set and the corresponding target field set.

12. The electronic device of claim 11, wherein the instructions causing the electronic device to retrieve the target data table set from the database further cause the electronic device:
retrieve a first data table set from the database based on the user query and the data table summary;
retrieve a second data table set from the database based on the user query and the field name; and
determine the target data table set based on the first data table set and the second data table set.

13. The electronic device of claim 12, wherein the instructions causing the electronic device to retrieve the target data table set from the database further cause the electronic device:
generate a query vector of the user query through a pre-trained model;
obtain a summary vector of the data table summary from a vector library, the summary vector being generated through the pre-trained model;
retrieve the first data table set from the database by determining a vector similarity between the query vector and the summary vector;
obtain a field vector of the field name from the vector library, the field vector being generated through the pre-trained model;
retrieve the second data table set from the database by determining a vector similarity between the query vector and the field vector; and
determine the target data table set by performing deduplication and fusion on the first data table set and the second data table set.

14. The electronic device of claim 11, wherein the instructions causing the electronic device to retrieve the target field set from each data table in the target data table set further cause the electronic device:
retrieve a first field set from each data table in the target data table set based on the user query and the field name;
retrieve a second field set from each data table in the target data table set based on the user query and a field vector of the field name; and
determine the target field set of each data table in the target data table set based on the first field set and the second field set.

15. The electronic device of claim 14, wherein the instructions causing the electronic device to retrieve the target field set from each data table in the target data table set further cause the electronic device:
generate a rewritten user query based on domain knowledge associated with the user query;
retrieve the first field set from each data table in the target data table set by determining a literal similarity between the rewritten user query and the field name;
generate a query vector of the user query through a pre-trained model;
retrieve the second field set from each data table in the target data table set by determining a vector similarity between the query vector and the field vector; and
determine the target field set by performing deduplication and fusion on the first field set and the second field set based on a predefined rule.

16. The electronic device of claim 15, wherein the instructions causing the electronic device to retrieve the second field set from each data table in the target data table set further cause the electronic device:
determine a field heat based on field statistical data; and
retrieve the second field set based on the vector similarity and the field heat.

17. The electronic device of claim 11, the instructions further cause the electronic device:
obtain domain knowledge associated with the user query; and
generate a rewritten user query based on the user query and the domain knowledge.

18. The electronic device of claim 11, the instructions further cause the electronic device:
generate prompt information based on the user query and the target data table set;
generate a semantic ranking score of the target data table set using a pre-trained model based on the prompt information; and
retrieve a third data table set from the target data table set based on the semantic ranking score.

19. The electronic device of claim 18, the instructions further cause the electronic device:
determine a heat ranking score of the third data table set based on table statistical data of each data table in the third data table set; and
retrieve a fourth data table set from the third data table set based on the heat ranking score.

20. A computer program product, the computer program product is tangibly stored on a non-transitory computer-readable medium and comprises computer-executable instructions, the computer-executable instructions, when executed by a computer, causing the computer:
determine a table query similarity between a user query and each data table in a database based on the user query, a data table summary, and a field name;
retrieve a target data table set from the database based on the table query similarity, the target data table set comprising data associated with the user query;
determine a field query similarity between the user query and each field of each data table in the target data table set based on the user query and the field name;
retrieve a target field set from each data table in the target data table set based on the field query similarity; and
determine a retrieval result of the data retrieval based on the target data table set and the corresponding target field set.
